(19) United States
(12) Patent Application Publication
(10) Pub. No.: US 2011/0024407 A1
(43) Pub. Date: Feb. 3, 2011

(54) ANNEALING APPARATUS

(75) Inventors: Shigeru Kasai, Yamanashi (JP); Tomohiro Suzuki, Yamanashi (JP)

Correspondence Address: THE NATH LAW GROUP, 112 South West Street, Alexandria, VA, 22314, US

(73) Assignee: TOKYO ELECTRON LIMITED, Tokyo (JP)

(21) Appl. No.: 12/936,599

(22) PCT Filed: Apr. 3, 2009
(86) PCT No.: PCT/JP2009/056962

§ 371 Date: Oct. 6, 2010

(30) Foreign Application Priority Data
Apr. 11, 2008 (JP) 2008-103160

(51) Int. Cl. H05B 1/00

(52) U.S. Cl. 219/220

(57) ABSTRACT

An annealing apparatus is provided with a chamber 2 wherein a wafer W is stored. Heating sources 17a and 17b have a plurality of LEDs 33 for irradiating the wafer W in the chamber 2 with light. A power supply section 60 is included for feeding the LEDs 33 of the heating sources 17a and 17b with power. Power feed control sections 42a and 42b are provided which control power feed from the power supply section 60 to the LEDs 33. Light transmitting members 18a and 18b are provided which transmit light emitted from the LEDs 33. An exhaust mechanism for exhausting inside the chamber 2 is provided. The power feed control sections 42a and 42b drive the LEDs 33 with direct current.

### CROSS-REFERENCE TO RELATED APPLICATIONS

This is a National Phase Application filed under 35 USC 371 of International Application No. PCT/JP2009/056962, filed on Apr. 03, 2009, an application claiming foreign priority benefits under 35 USC 119 of Japanese Patent Application No. 2008-103160, filed on Apr. 11, 2008, the entire content of each of which is hereby incorporated by reference.

### TECHNICAL FIELD

The present invention relates to an annealing apparatus for executing an annealing operation on a semiconductor wafer by irradiating a light from a light-emitting element such as a light-emitting diode (LED).

### BACKGROUND

In manufacturing a semiconductor device, provided are various heat treatments such as a film forming treatment, an oxidation diffusion treatment, a surface modification treatment, an annealing treatment and the like for a semiconductor wafer (hereinafter, “wafer”) to be processed. However, with an ongoing need for higher speed and higher integration of the semiconductor device, an annealing operation, after an ion implantation in particular, is intended to heat and cool at a higher speed in order to minimize diffusion. It has been considered for an annealing apparatus capable of such heating and cooling with higher speed, which uses a light-emitting element, i.e., a light-emitting diode (LED) as a heating source, (for example, WO 2004/015348).

However, when the LED is used as the heating source of the annealing apparatus, it is necessary to generate great light energy in response to rapid heating and thus to mount the LED with high density.

According to such an annealing apparatus using the LED, a light amount of the LED is controlled by controlling a power feed to the LED, thereby embodying a predetermined temperature profile. For controlling the power feed to the LED, there have been suggested a resistance control, a constant current diode control, a PWM (Pulse Width Modulation) control and the like.

Among them, the resistance control costs less but causes a resistance joule loss in a control section, thereby causing efficiency deterioration. Further, the constant current control using a constant current diode allows the current constant by causing a loss in the diode, thereby causing the joule loss in the diode. For this reason, the PWM control having a good efficiency has been mainly used in a large scale system.

However, the LED is formed of compound semiconductors including GaN, GaAs and the like, and there is a junctional resistance between the semiconductor and an electrode. Thus, when an LED with high brightness is driven, if the LED is driven by the conventional PWM control (PWM drive), the loss in the control section can be reduced but a loss in an LED portion is increased in proportion to a control current. Accordingly, when a brightness (light amount) control of the LED is actually executed, the loss in the LED becomes relatively greater. Further, there are disadvantages in that the efficiency is deteriorated by such a loss and a light-emitting amount of the LED is deteriorated by a heat generated by such a loss. For this reason, there is a demand to further reduce the loss.

### SUMMARY

An object of the present invention is to provide an annealing apparatus, which uses a light-emitting element such as an LED as a heating source and is capable of reducing a loss in the light-emitting element.

According to the present invention, provided is an annealing apparatus comprising: a treatment room wherein a workpiece is stored; a heating source disposed so as to face at least one surface of the workpiece and having a plurality of light-emitting elements configured to irradiate the workpiece with light; a power supply section configured to feed the light-emitting elements of the heating source with power; a power feed control section configured to control power feed from the power supply section to the light-emitting elements; a light transmitting member configured to be in response to the heating source, the light transmitting member being configured to transmit light from the light-emitting elements; and an exhaust mechanism configured to exhaust inside the treatment room, wherein the power feed control section drives the light-emitting elements with direct current.

The present invention may further comprise a cooling member supporting an opposite side to the treatment room of the light transmitting member, the cooling member being made of high thermal conductive materials for cooling the heating source, and a cooling mechanism for cooling the cooling member with a cooling medium.

In this case, the heating source may be configured to comprise a plurality of light-emitting element arrays formed by unitizing: a support made of high thermal conductive insulating materials configured to support the plurality of the light-emitting elements on a surface; a thermal diffusion member made of high thermal conductive materials and bonded to a rear surface side of the support; and a plurality of power feed electrodes configured to pass through the thermal diffusion member and the support so as to feed the light-emitting elements with power; wherein the light-emitting element arrays are disposed on the cooling member. Further, it is preferred that the cooling member and the thermal diffusion member are made of copper materials and the support is made of AlN materials.

Further, the present invention may be configured to include a space between the cooling member and the light transmitting member, the heating source being disposed within the space.

Also, the present invention may use a light-emitting diode (LED) as the light-emitting element.

According to the present invention, in the annealing apparatus using the light-emitting element such as the LED, the power feed control section for controlling the power feed from the power supply section to the light-emitting element drives the light-emitting elements with direct current. In the case of the direct current drive, unlike the conventional PWM drive, since the loss is proportional to the square of the control current, the loss in the light-emitting element can be reduced in a power region of 50 to 80% actually used in a temperature control. Thus, a deterioration of the light-emitting amount by heat generation can be restrained and high efficiency is obtained. Further, the direct current drive means a drive manner wherein the light-emitting element is not driven on-off with a pulsed voltage as in the conventional PWM drive, but the light-emitting element is always ON and an amount of the current flow varies depending on time, but a direction thereof does not change.

### BRIEF DESCRIPTION OF THE DRAWINGS

FIG. 1 is a schematic cross-sectional view of an annealing apparatus in one embodiment according to the present invention.

FIG. 2 is an expanded view of a heating source of the annealing apparatus in FIG. 1.

FIG. 3 is an expanded view of a portion of feeding an LED of the annealing apparatus with power in FIG. 1.

FIG. 4 is a view of a specific arrangement of the LEDs in an LED array and a method of feeding the power in the annealing apparatus in FIG. 1.

FIG. 5 is a view of explaining a connecting manner of the LEDs in the annealing apparatus in FIG. 1.

FIG. 6 is a bottom view of the heating source of the annealing apparatus in FIG. 1.

FIG. 7 is a view of an equivalent circuit of the LED.

FIG. 8 is a view of a relationship between a control current and a loss in a direct current drive and a PWM drive.

FIG. 9 is a view of an example of a temperature profile when a wafer is heated by the annealing apparatus according to an embodiment of the present invention.

FIG. 10 is a view of a current profile for obtaining the temperature profile in FIG. 9.

FIG. 11 is a view of a relationship between the control current and a light power in the direct current drive and the PWM drive.

### DETAILED DESCRIPTION

An embodiment of the present invention will be specifically described below, with reference to the attached drawings. Here, for example, provided is an annealing apparatus for annealing a wafer provided with a surface to which impurities are injected.

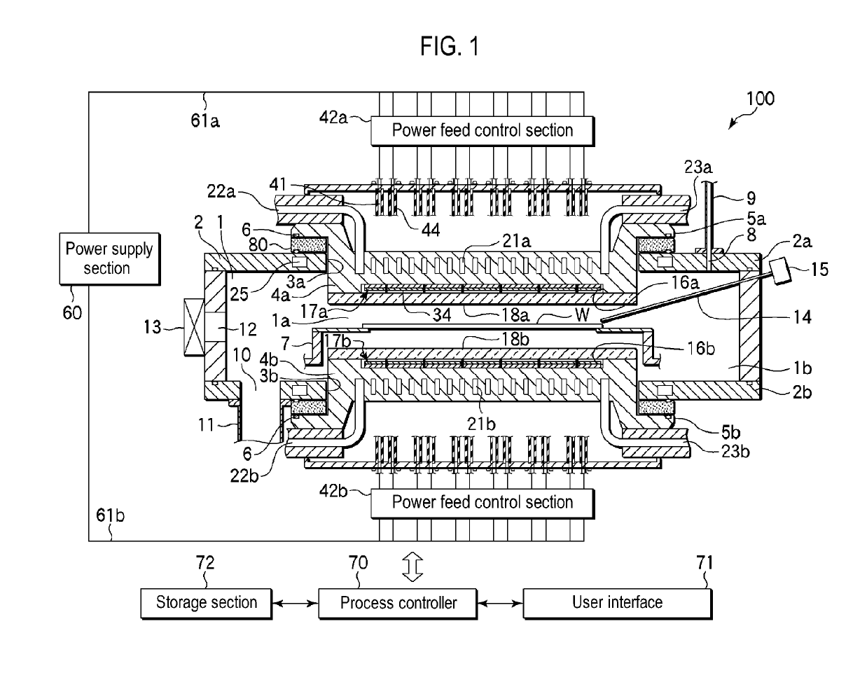

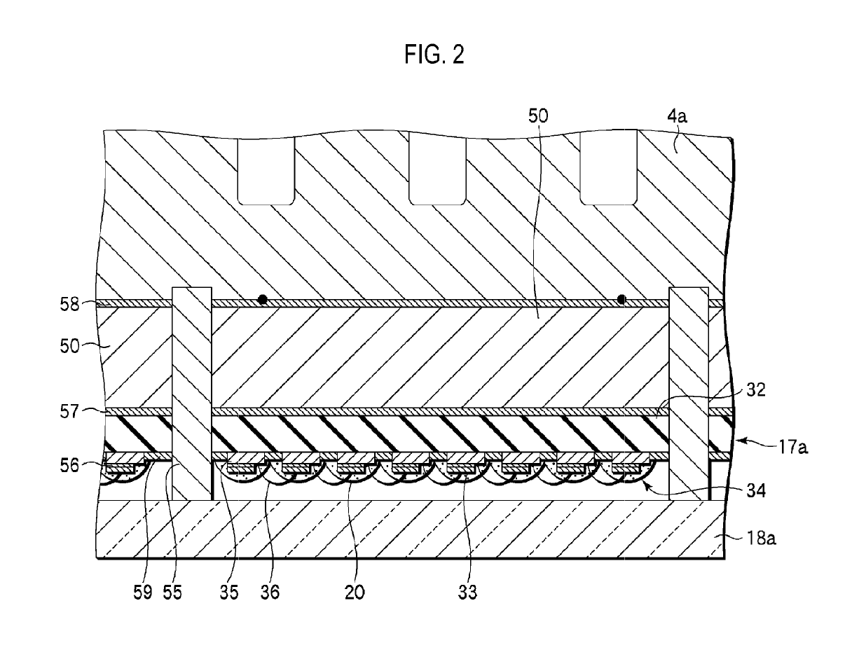

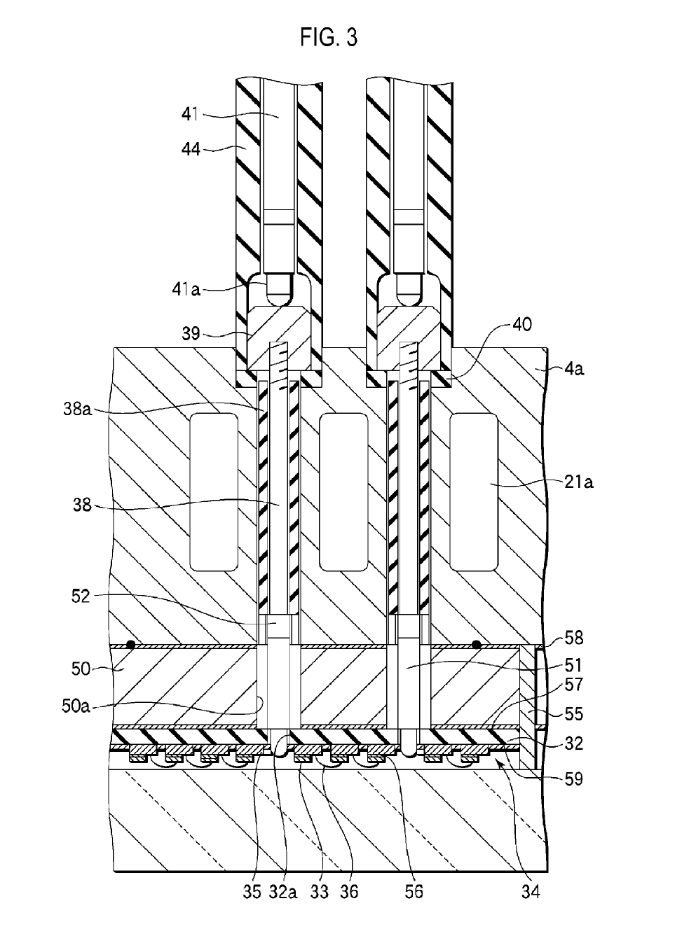

FIG. 1 is a schematic cross-sectional view of an annealing apparatus in one embodiment according to the present invention, FIG. 2 is an expanded view of a heating source of the annealing apparatus in FIG. 1, and FIG. 3 is an expanded view of a portion of feeding an LED of the annealing apparatus with power in FIG. 1.

The annealing apparatus 100 comprises a treatment room 1 configured in an air-tight manner in which a wafer W is carried. The treatment room 1 comprises a cylindrical shaped annealing treatment section 1a in which the wafer W is disposed, and a gas diffusion section 1b disposed in a donut shape in an outer side of the annealing treatment section 1a. A height of the gas diffusion section 1b is higher than that of the annealing treatment section 1a and a cross-section of the treatment room 1 has an H-shape. The gas diffusion section 1b of the treatment room 1 is defined by a chamber 2. An upper wall 2a and a lower wall 2b of the chamber 2 are provided with circular holes 3a and 3b corresponding to the annealing treatment section 1a, and cooling members 4a and 4b made of high thermal conductive materials such as Al or Al alloy are inserted the holes 3a and 3b, respectively. The cooling members 4a and 4b comprise flange sections 5a and 5b and the flange sections 5a and 5b are supported by a heat insulator 80 such as ULTEM® on the upper wall 2a and the lower wall 2b of the chamber 2. The heat insulator 80 is disposed in order to minimize a heat entrance from the chamber 2 since the flange sections 5a and 5b are cooled to −50° C. or less, for example, as will be explained below. Seal members 6 are interposed between the flange sections 5a and 5b and the heat insulator 80 and between the heat insulator 80 and the upper and lower walls 2a and 2b, to thereby adhere therebetween. Further, a portion of the cooling members 4a and 4b exposed to atmosphere is covered with a heat insulating material.

The treatment room 1 is provided with a support member 7 for horizontally supporting the wafer W in the annealing treatment section 1a, and the support member 7 is configured to be liftable by a lifting mechanism (not shown) when the wafer W is delivered. Further, a top wall of the chamber 2 is provided with a treatment gas introduction port 8 to which a predetermined treatment gas is introduced from a treatment gas supply mechanism (not shown), and the treatment gas introduction port 8 is connected with a treatment gas pipe 9 for supplying the treatment gas. Also, the lower wall of the chamber 2 is provided with an exhaust port 10, and the exhaust port 10 is connected with an exhaust pipe 11 connected to an exhaust device (not shown). Further, a side wall of the chamber 2 is provided with a carrying in-out port 12 for executing a carrying in-out of the wafer W to the chamber 2, and the carrying in-out port 12 is configured to be opened and closed by a gate valve 13. The treatment room 1 is provided with a temperature sensor 14 for measuring a temperature of the wafer W supported on the support member 7. Further, the temperature sensor 14 is connected to a measuring section 15 in an outer side of the chamber 2, and the measuring section 15 is configured to output its temperature detecting signal to a process controller 70 which will be explained below.

Surfaces of the cooling members 4a and 4b opposed to the wafer W supported on the support member 7 are provided with circular recesses 16a and 16b so as to correspond to the wafer W supported on the support member 7. Further, the recesses 16a and 16b are provided with heating sources 17a and 17b on which light-emitting diodes (LED) are mounted so as to directly contact with the cooling members 4a and 4b.

Surfaces of the cooling members 4a and 4b opposed to the wafer W are provided with light transmitting members 18a and 18b fixed with screws so as to cover the recesses 16a and 16b, which transmit a light from the LEDs mounted on the heating sources 17a and 17b to the wafer W side. The light transmitting members 18a and 18b are made of materials, which effectively transmit the light emitted from the LED, including quartz, for example.

The cooling members 4a and 4b are provided with cooling medium passages 21a and 21b, and a liquid cooling medium, which can cool the cooling members 4a and 4b to 0° C. or less, for example, about −50° C., such as a fluorine-based inert liquid (Product name: Fluorinert, Galden and the like), flows through the cooling medium passages 21a and 21b. The cooling medium passages 21a and 21b of the cooling members 4a and 4b are connected with cooling medium supply pipes 22a and 22b and cooling medium discharge pipes 23a and 23b. Thus, the cooling medium passages 21a and 21b are configured to be capable of circulating the cooling medium thereinto, thereby cooling the cooling members 4a and 4b.

Further, a cooling water passage 25 is disposed in the chamber 2 such that cooling water with a room temperature flows therethrough, thereby preventing a temperature of the chamber from excessively increasing.

As expanded and shown in FIG. 2, the heat sources 17a and 17b include a plurality of LED arrays 34, and the LED array 34 comprise a support 32 made of high thermal conductive materials having insulating property such as AlN ceramics; a plurality of LEDs 33 supported on the support 32 via electrodes 35; and a thermal diffusion member 50 bonded to a rear surface side of the support 32 and made of high thermal conductive material, i.e., Cu. The support 32 is patterned with the electrodes 35, which have a high conductivity and formed by plating gold on copper, for example, and the LEDs 33 are disposed in the electrodes 35 by a silver paste 56, which is a bonding material having high thermal conductivity. Further, the support 32 and the thermal diffusion member 50 are bonded by a solder 57, which is a high thermal conductive bonding material in view of reliability. Also, the cooling member 4a (4b) and the thermal diffusion 50 at a rear surface side of the LED array 34 are fixed with screws while a silicon grease 58, which is a high thermal conductive bonding material, is interposed therebetween. According to such a configuration, a cold heat transferred from the cooling medium to the cooling members 4a and 4b having high thermal conductivity in high efficiency arrives in the LEDs 33 via the thermal diffusion member 50, which contacts in an entire surface and has high thermal conductivity, the support 32 and the electrodes 35. That is, heat generated in the LEDs 33 can be very effectively dissipated to the cooling members 4a and 4b cooled by the cooling medium via a path having good thermal conductivity, i.e., the silver paste 56, the electrode 35, the support 32, the solder 57, the thermal diffusion member 50 and the silicon grease 58.

One LED 33 and the electrode 35 of its adjacent LED 33 are connected by a wire 36. Further, a portion of a surface of the support 32, in which the electrode 35 is not disposed, is provided with a reflective layer 59 containing, for example, TiO₂ such that a light emitted from the LED 33 to the support 32 side is reflected to be effectively extracted (obtained). It is preferred that the reflective layer 59 has 0.8 or more reflectivity (reflectance).

A reflective plate 55 is disposed between the adjacent LED arrays 34 and thus, an entire periphery of the LED arrays 34 is surrounded by the reflective plate 55. The reflective plate 55 may be formed by plating gold on a Cu plate, thereby reflecting a light toward a transverse direction to be effectively extracted.

Each LED 33 is covered with a lens layer 20 made of, for example, a transparent resin. The lens layer 20 serves to extract the light emitted from the LED 33 and can extract a light from a side surface of the LED 33 as well. A shape of the lens layer 20 is not specifically limited as far as having a lens function but is preferably a dome shape in view of easiness and efficiency in manufacturing. The lens layer 20 has refractivity between the LED 33 having high refractivity and air having refractivity as 1, and is disposed in order to relieve a total reflection resulting from the light being directly emitted from the LED 33 to the air.

A space between the support 32 and the light transmitting members 18a and 18b is vacuumed so that both sides (upper and lower surfaces) of the light transmitting members 18a and 18b become a vacuum state. Thus, the light transmitting members 18a and 18b can be configured to be thinner than those serving as a partition between an atmosphere state and a vacuum state.

Power is fed from a power supply section 60 to the LED 33 of the heating source 17a via a power feed wire 61a, a power feed member 41 and an electrode stick 38 (see FIG. 3), and power is fed from the power supply section 60 to the LED of the heating source 17b via a power feed wire 61b, the power feed member 41 and the electrode stick 38. The power supply wires 61a and 61b are connected with power feed control sections 42a and 42b.

As expanded and shown in FIG. 3, power feed electrodes 51 are inserted into holes 50a and 32a respectively formed in the thermal diffusion member 50 and the support 32, and the power feed electrodes 51 are connected to the electrodes 35 by a solder. The power feed electrodes 51 are connected with the electrode sticks 38, which extend via an inside of the cooling members 4a and 4b, in an installing port 52. A plurality of the electrode sticks 38, for example, eight electrode sticks 38 (only two electrode sticks are shown in FIG. 3) are disposed in each LED array 34, and the electrode sticks 38 are covered with protective covers 38a, which are made of insulating materials. The electrode sticks 38 extend to an upper end of the cooling member 4a and a lower end of the cooling member 4b where a housing member 39 is fixed with a screw. An insulating ring 40 is interposed and mounted between the housing member 39 and the cooling members 4a and 4b. Here, gaps between the protective cover 38a and the cooling member 4a (4b) and between the protective cover 38a and the electrode stick 38 are brazed to form a so-called feed through.

The power feed member 41 is connected to the housing member 39 disposed in each electrode stick 38. The power feed member 41 is covered with a protective cover 44 made of insulating materials. A leading end of the power feed member 41 is provided with a pogo pin (spring pin) 41a, and each pogo pin 41a contacts with the corresponding housing member 39. Thereby, the power supply section 60 feeds power to each LED 33 of the heating source 17a via the power feed wire 61a, the power feed member 41, the electrode stick 38, the power feed electrode 51 and the electrode 35 and to each LED 33 of the heating source 17b via the power feed wire 61b, the power feed member 41, the electrode stick 38, the power feed electrode 51 and the electrode 35. In this case, the power feed control sections 42a and 42b feed the power by feeding an output from the power supply section 60 to the LEDs 33 as a voltage or current in a direct current waveform. That is, the LEDs are driven with direct current. The power feed to the LEDs was generally executed by the PWM drive for applying a voltage (current) in a pulse shape with a predetermined duty ratio in the past. However, according to such a direct current drive, a heat generation margin and efficiency is improved. Further, the direct current drive means a drive wherein the LED is not ON-OFF driven in a pulsed manner as in the conventional PWM drive, but the LED is always ON and an amount of the current flowing varies depending on time, but a direction thereof does not change.

Since the power feed is executed as above, the LEDs 33 are light-emitted and both sides of the wafer W are heated by this light to thereby execute an annealing treatment. Since the pogo pin (41a) is compressed toward the housing member 39 by a spring, a contact between the power feed member 41 and the electrode stick 38 can be secured.

Further, FIG. 1 shows the power feed member 41 to a middle thereof, and the electrode stick 38, the power feed electrode 51 and a configuration of their connecting portions are omitted. Also, the power feed electrode 51 is omitted in FIG. 2.

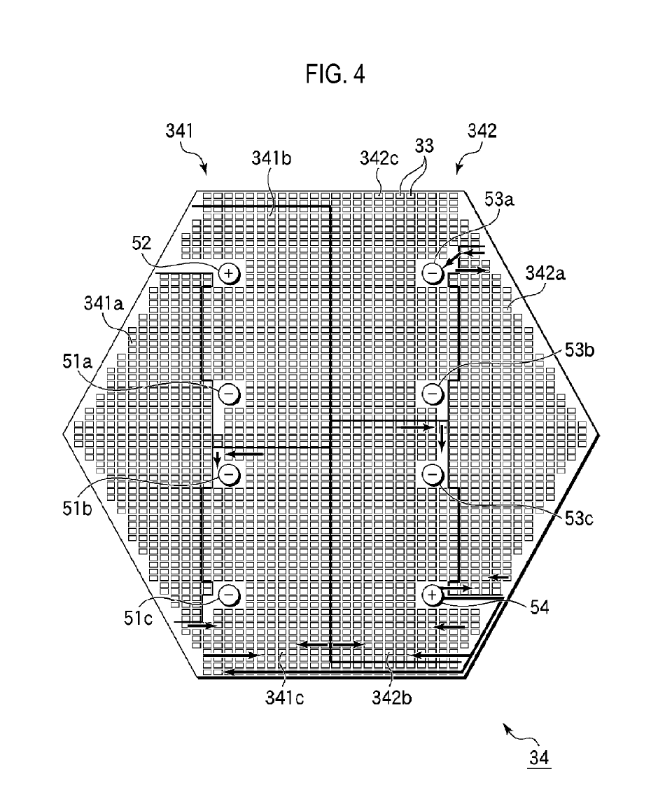

As shown in FIG. 4, the LED array 34 has a hexagonal shape. For the LED array 34, it is preferable to increase the number of the LEDs 33 to be mounted by supplying sufficient voltage to each LED 33 and reducing an area loss in a power feed section. Here, the LED array 34 is divided into two areas 341 and 342, and these areas 341 and 342 are divided into three power feed areas 341a, 341b, 341c and 342a, 342b, 342c, respectively.

As for the electrode for feeding the power to these power feed areas, three cathodes 51a, 51b, 51c and one common anode 52 are straightly arranged in the area 341 side, and three cathodes 53a, 53b, 53c and one common anode 54 are straightly arranged in the area 342 side. Further, it is configured to feed power from the common anode 52 to the power feed areas 341a, 341b, 341c and from the common anode 54 to the power feed areas 342a, 342b, 342c.

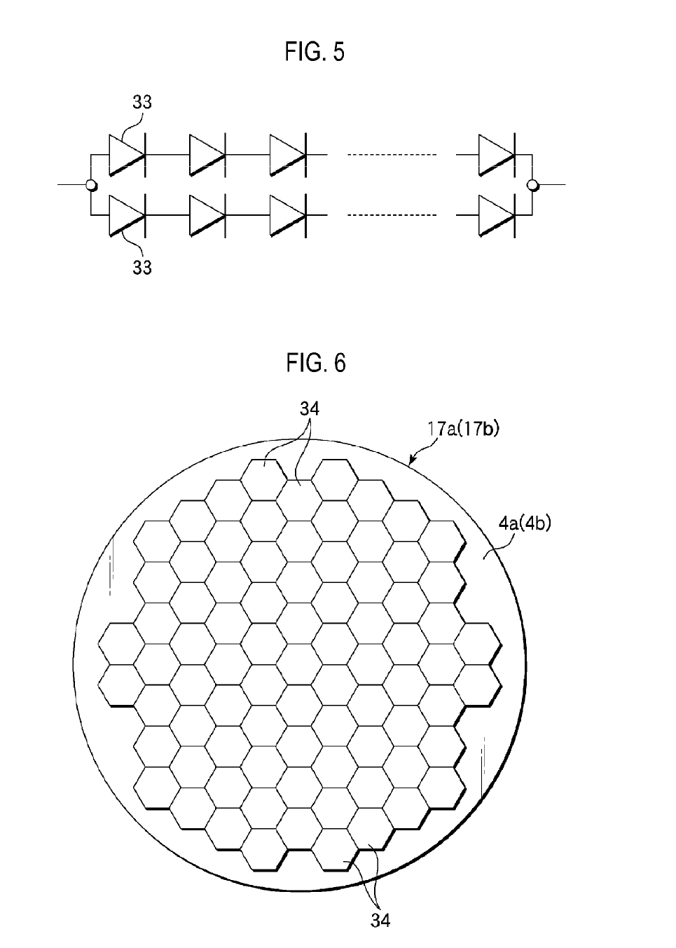

As shown in FIG. 5, two sets of a plurality of the LEDs 33 in each power feed area, which are serially connected, are disposed in parallel. By doing so, variations in each LED and in the voltage can be restrained.

The LED arrays 34 having such a configuration are disposed on the cooling member 4a (4b) without gaps as shown in FIG. 6. A thousand to two thousands of the LEDs 33 are mounted on one LED array 34. A light emitted from the LED 33 has a wavelength ranging from an ultraviolet ray to a near infrared ray, preferably ranging from 0.36 to 1.0 μm. A material for emitting such a light ranging from 0.36 to 1.0 μm may include a compound semiconductor comprising GaN, GaAs, GaP and the like as a base. Among them, it is preferred that the compound semiconductor is made of GaAs-based material having an irradiation wavelength ranging from about 850 to about 970 nm with high absorption with regard to the wafer W made of silicon used as a workpiece to be heated.

As shown in FIG. 1, each part of the annealing apparatus 100 is configured to be connected and controlled by a process controller 70 provided with a microprocessor (computer). For example, this process controller 70 executes a transmission of a control command for the power feed control sections 42a and 42b, a control of a drive system, a gas supply control and the like. The process controller 70 is connected with a user interface 71 comprising a keyboard, through which an operator executes an input operation of a command in order to manage the annealing apparatus 100, or a display for visualizing and displaying an operating situation of the annealing apparatus 100. Further, the processor controller 70 is connected with a storage section 72 for storing treatment recipes, that is, a control program for embodying various treatments executed in the annealing apparatus 100 by controlling the process controller 70 or a program for executing treatments in each part of the annealing apparatus 100 depending on treatment conditions. The treatment recipes may be stored in a fixed storage medium such as a hard disc or set in a predetermined position of the storage section 72 while being housed in a mobile storage medium such as CD-ROM, DVD and the like. Further, the treatment recipes may be appropriately transferred from other devices via a dedicated line, for example. Also, if necessary, since a given treatment recipe is called from the storage section 72 by an instruction from the user interface 71 and executed in the process controller 70, a desired treatment in the annealing apparatus 100 is executed under control of the process controller 50.

Next, an operation for executing an annealing treatment in the annealing apparatus 100 configured as above will be explained.

First, the gate valve 13 is open and thus, the wafer W is carried from the carrying in-out port 12 and then loaded on the support member 7. Then, the gate valve 13 is closed to seal the treatment chamber 1, and the treatment chamber 1 is exhausted by an exhaust device (not shown) via the exhaust port 10 and simultaneously, a predetermined treatment gas such as Ar gas or N gas is introduced from a treatment gas supply mechanism (not shown) via the treatment gas pipe 9 and the treatment introduction port 8 into the treatment chamber 1, thereby maintaining a pressure in the treatment chamber 1 as a predetermined pressure ranging from about 100 to about 10000 Pa, for example.

Meanwhile, the cooling members 4a and 4b circulate a liquid cooling medium such as a fluorine-based inert liquid (Product name: Fluorinert, Galden and the like) in the cooling medium passages 21a and 21b, thereby cooling the LEDs 33 to a predetermined temperature equal to or less than 0° C., preferably, −50° C. or less.

Further, the power is fed from the power supply section 60 via the power feed wire 61a, the power feed member 41, the electrode stick 38, the power feed electrode 51 and the electrode 35 to each LED 33 of the heating source 17a, and the power is fed from the power supply section 60 via the power feed wire 61b, the power feed member 41, the electrode stick 38, the power feed electrode 51 and the electrode 35 to each LED 33 of the heating source 17b, thereby light-emitting the LEDs 33.

The light from the LED 33 is transmitted via the lens layer 20 directly or after being reflected in the reflective layer 59 first, and then and transmitted the light transmitting members 18a and 18b, thereby heating the wafer W with an extremely high speed using an electromagnetic radiation by a re-coupling of an electron and a hole.

Here, when the LED 33 is maintained at room temperature, since a light-emitting amount of the LED 33 is reduced due to its own heating, as shown in FIG. 2, the LED 33 is cooled via the cooling members 4a and 4b, the thermal diffusion member 50, the support 32 and the electrode 35 by flowing the cooling medium through the cooling members 4a and 4b, thereby restraining the reduction of the light-emitting amount.

Meanwhile, the power feed to the LED 33 is controlled by the power feed control sections 42a and 42b. In the present embodiment, the direct current drive is adopted, and thus, the power feed is executed to the LED 33 by feeding an output from the power supply section 60 as a voltage or current in a direct current waveform by the power feed control sections 42a and 42b. That is, unlike ON-OFF driving the LED in a pulsed manner as in the conventional PWM drive, the LED is always ON and an amount of the current flowing varies depending on time, but a direction thereof does not change.

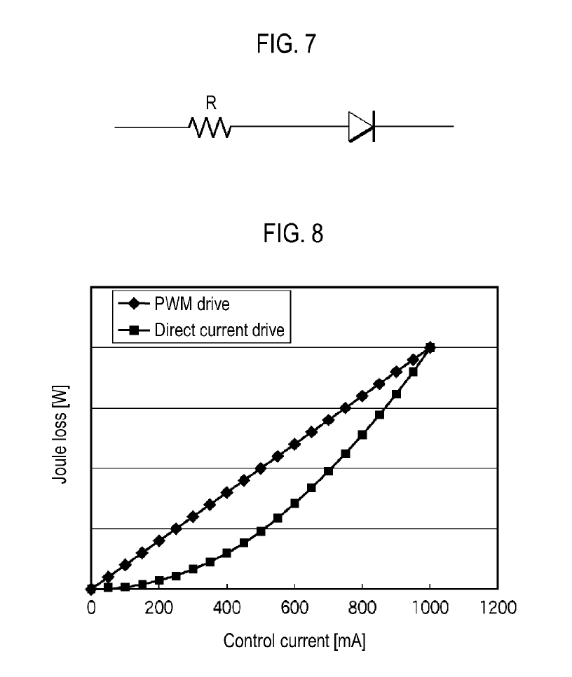

Here, a relationship between a control current and a loss in the PWM drive and the direct current drive will be explained. Assuming that the LED 33 has an equivalent circuit as in FIG. 7 and the LED 33 is driven in the PWM drive with an X % of the duty ratio and a current having its height as 1000 mA (1A), a loss per one cycle becomes 1×1×R×(X/100)(W) and an average current per one cycle becomes 1×(X/100)(A). Here, since a section for (1×1×R) in the loss is not changed even though the duty ratio varies, the loss is proportional to the average current. Meanwhile, in the case of the direct current drive, the loss is proportional to the square of the current flowing at that time. Such relationships are compared and shown in FIG. 8. As shown in this figure, while the loss is proportional to the control current in the PWM drive, the loss is proportional to the square of the control current in the direct current drive. When a current is 1000 mA (1A), which is the control current in a full power, the losses in both drives become identical, and when the control current is smaller than the full power, the loss in the direct current drive becomes smaller than the loss in the PWM drive. Further, although FIG. 8 shows when the control current in the full power is 1000 mA, the losses in both drives become identical when the current is in the full power regardless of such a value.

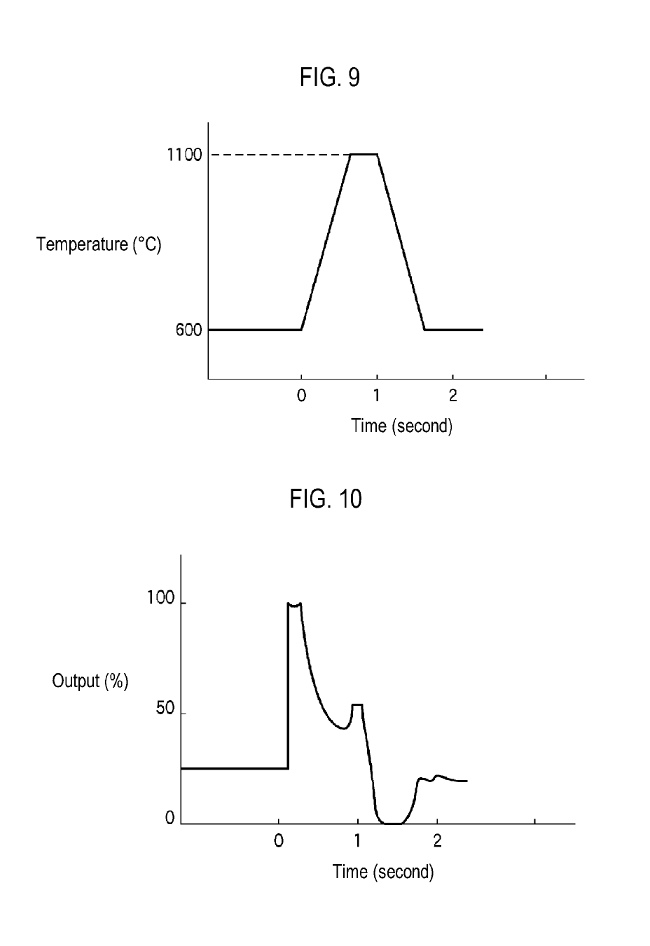

When the wafer W is heated by the annealing apparatus 100 according to the present embodiment, a temperature profile is required wherein the wafer W is rapidly heated to a target temperature (for example, 1100° C.) in a ramp shape and maintained for a short time and then rapidly cooled as shown in FIG. 9. A current profile in this case becomes as shown in FIG. 10. FIG. 10 shows an output (control current) in the vertical axis with %. Since a time of the full power (100% of the output) is very short, the time of the full power is barely 20% or less of a temperature increase period for increasing the temperature to 600° C. or more. Further, since most of the temperature increase period is controlled with the current less than the full power, an efficiency (loss) of that time becomes important. As described above, the loss in the direct current drive is smaller than the loss in the PWM drive in when the power is smaller than the full power. Accordingly the direct current drive lessens the loss than the PWM drive when such a rapid temperature increase or decrease is executed.

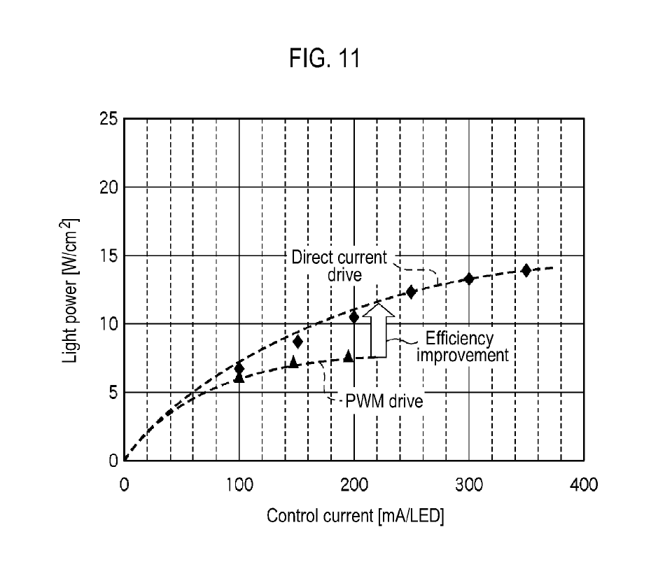

FIG. 11 shows an actual measurement data. FIG. 11 shows a relationship between the control current of one LED in the horizontal axis and the light power in the vertical axis. As shown in this figure, in a region of around 60 mA and more of the control current, the light power of the LED is increased in the direct current drive, rather than in the PWM drive. Thus, the heat generation margin is improved in the direct current drive and the efficiency is improved.

Further, the present invention is not limited to the above embodiment but may include various modifications. For example, although the above embodiment illustrates the case of disposing the heating sources provided with the LEDs at both sides of the wafer (workpiece), the heating source may be disposed at any one side of the wafer. Also, although the above embodiment illustrates the case of using the LED as the light-emitting element, other light-emitting elements such as a semiconductor laser may be used. Further, the workpiece is not limited to the semiconductor wafer but may include a glass substrate for FPD and the like.

The present invention may be applicable for a use requiring a rapid heating operation such as an annealing treatment of a semiconductor wafer after impurities are injected.

What is claimed is:

1. An annealing apparatus comprising:
a treatment room wherein a workpiece is stored;
a heating source disposed so as to face at least one surface of the workpiece, the heating source having a plurality of light-emitting elements configured to irradiate the workpiece with light;
a power supply section configured to feed the light-emitting elements of the heating source with power;
a power feed control section configured to control power feed from the power supply section to the light-emitting elements;
a light transmitting member configured to be in response to the heating source, the light transmitting member being configured to transmit light from the light-emitting elements; and
an exhaust mechanism configured to exhaust inside the treatment room,
wherein the power feed control section drives the light-emitting elements with direct current.

2. The annealing apparatus of claim 1, further comprising a cooling member supporting an opposite side to the treatment room of the light transmitting member, the cooling member being made of high thermal conductive materials for cooling the heating source; and a cooling mechanism for cooling the cooling member with a cooling medium.

3. The annealing apparatus of claim 2, wherein the heating source comprises a plurality of light-emitting element arrays formed by unitizing:
a support made of high thermal conductive insulating materials configured to support the plurality of the light-emitting elements on a surface;
a thermal diffusion member made of high thermal conductive materials and bonded to a rear surface side of the support; and
a plurality of power feed electrodes configured to pass through the thermal diffusion member and the support so as to feed the light-emitting elements with power,
wherein the light-emitting element arrays are disposed on the cooling member.

4. The annealing apparatus of claim 3, wherein the cooling member and the thermal diffusion member are made of copper materials, and the support is made of AlN materials.

5. The annealing apparatus of claim 2, wherein a space is defined between the cooling member and the light transmitting member, the heating source being disposed within the space.

6. The annealing apparatus of claim 1, wherein the light emitting element is an LED.
